(19) United States
(12) Patent Application Publication
(10) Pub. No.: US 2004/0136085 A1
(43) Pub. Date: Jul. 15, 2004

(54) Variable-curvature lens system and method for adjusting curvature thereof

(75) Inventor: Chih-Wen Huang, Hsin-Chu City (TW)

Correspondence Address: LOWE HAUPTMAN GILMAN AND BERNER, LLP, 1700 DIAGONAL ROAD, SUITE 300 /310, ALEXANDRIA, VA, 22314, US

(73) Assignee: VEUTRON CORPORATION

(21) Appl. No.: 10/341,492

(22) Filed: Jan. 14, 2003

(51) Int. Cl. G02B 15/14

(52) U.S. Cl. 359/676

(57) ABSTRACT

A variable-curvature lens system and a method for adjusting curvature thereof are provided. The variable-curvature lens system includes a plurality of lenses having at least one plastic lens and a thermal controller associated with the plastic lens. The curvature of the plastic lens is determined depending upon the ambient temperature controlled by the thermal controller. When the lens system is adapted to an image readout apparatus, a focus length of the whole lens system mates with an optimum MTF value can be obtained by way of controlling ambient temperature of the plastic lens by the thermal controller. A high-performance, high-resolution image output thus can be provided.

### BACKGROUND OF THE INVENTION

1. Field of the Invention

The present invention relates to a variable-curvature lens system, and more particular to a lens system including at least a plastic lens associated with a thermal controller adapted to an image readout apparatus.

2. Description of the Prior Art

In a color image readout optical system, employed in an image scanner or the like, of a type adapted to form a reduced or magnified image of an original onto an image device such as CCD, a three-element lens has conventionally been known as one which attains a smaller size and lower cost with a simple configuration.

Recently, as demands for this three-element lens to reduce its cost and weight have been increasing, an image readout lens using a plastic lens as its lens material has been known to fulfill these demands. Though a plastic lens is mainly advantageous in terms of its light weight and low cost as well as its easiness to be processed into an aspheric surface, the plastic lens has a tendency that its refractive index and shape change with temperature and humidity, and thus imaging performance is degraded by temperature change.

FIG. 1 is a schematic configuration of a conventional three-element lens system, which includes a plastic lens 10 positioned at an object side, a first glass lens 12 and a second glass lens 14 positioned at an image side. Since the material of the plastic lens 10 is strong temperature dependence, large deviations of image positions happen upon changes in temperature. For example, referring to FIG. 2, when the lens system of FIG. 1 is adapted to an image readout apparatus, such as a scanner, the total optical length of the image readout apparatus, i.e. total trace (TT), mating with the optimum modulation transfer function (MTF) value, could be shifted from T₀ to T₁ upon changes in ambient temperature of the lens system As a consequence, the focus point of the lens system and the position of the CCD need to be adjusted to mate with the optimum MTF value.

With the above conventional lens system arrangement, temperature-dependent variations in the refractive indices and focal lengths of the lens, particularly temperature-dependent variations in the total power of the lens system can not be eliminated. Hence, the conventional lens system fails to provide high resolution, brightness, and clear profiles for high image quality. By the way, although glass lens suffers small temperature-dependent variation in refractive indices and focal length, the glass lens is heavy, highly expensive and can not be ground with ease for producing aspheric surfaces. Besides, it is necessary to adjust the position of the glass lens system after assembled in the image readout apparatus to mate with an optimum MTF value due to the common difference of the glass lens from manufacturing process. It is more troublesome and highly cost for using the glass lens system in the image readout apparatus.

Accordingly, it is an intention to provide an improved lens system, which can overcome the drawbacks of the conventional lens system.

### SUMMARY OF THE INVENTION

It is one objective of the present invention to provide a variable-curvature lens system, which includes at least a plastic lens associated with a thermal controller. By controlling ambient temperature of the plastic lens with the thermal controller, the curvatures of the plastic lens can be controlled to mate with an optimum MTF (modulation transfer function) value, when employed in an image readout apparatus.

It is another objective of the present invention to provide a variable-curvature lens system, which includes at least a plastic lens associated with a thermal controller. When the lens system is adapted to an image readout apparatus, the curvature of the plastic lens can be controlled to mate with an optimum MTF value by the thermal controller so that the step for adjusting the focus of the lens system and the position of the charge-coupled device after assembling the components of the image readout apparatus can be omitted.

It is further an objective of the present invention to provide a variable-curvature lens system, which includes at least a plastic lens associated with a thermal controller. When the lens system adapted to an image readout apparatus, the plastic lens can thermally deform to have a curvature mating with an optimum MTF value based on the requirement of the scanning environment. A high-performance, high-resolution image output thus can be obtained.

In order to achieve the above objectives of this invention, the present invention provides a variable-curvature lens system, which includes a plurality of lenses having at least one plastic lens and a thermal controller associated with the plastic lens. The curvature of the plastic lens is determined depending upon the ambient temperature of the plastic lens controlled by the thermal controller. When the lens system is adapted to an image readout apparatus, the total focus length of the lens system can be adjusted by changing ambient temperature of the plastic lens with the thermal controller to mate with an optimum MTF value. As a result, a high-performance, high-resolution image output can be obtained.

### BRIEF DESCRIPTION OF THE DRAWINGS

The objectives and features of the present invention as well as advantages thereof will become apparent from the following detailed description, considered in conjunction with the accompanying drawings.

FIG. 1 is a schematic configuration of a conventional lens system;

FIG. 2 is diagram of MTF distribution verse total optical path (TT) when adapted the conventional lens system of FIG. 1 in an image readout apparatus;

FIG. 3A is a schematic configuration of a variable-curvature lens system in accordance with a first embodiment of the present invention;

FIG. 3B is a schematic configuration of a variable-curvature lens system in accordance with a second embodiment of the present invention;

FIG. 3C is a schematic configuration of a variable-curvature lens system in accordance with a third embodiment of the present invention;

FIG. 4 is a schematic cross-sectional view of a scanner, showing a test chart placing in a slant manner above a scanning board thereof; and

FIG. 5 is a flow chart of one example illustrating the present method for adjusting curvature of the variable-curvature lens system.

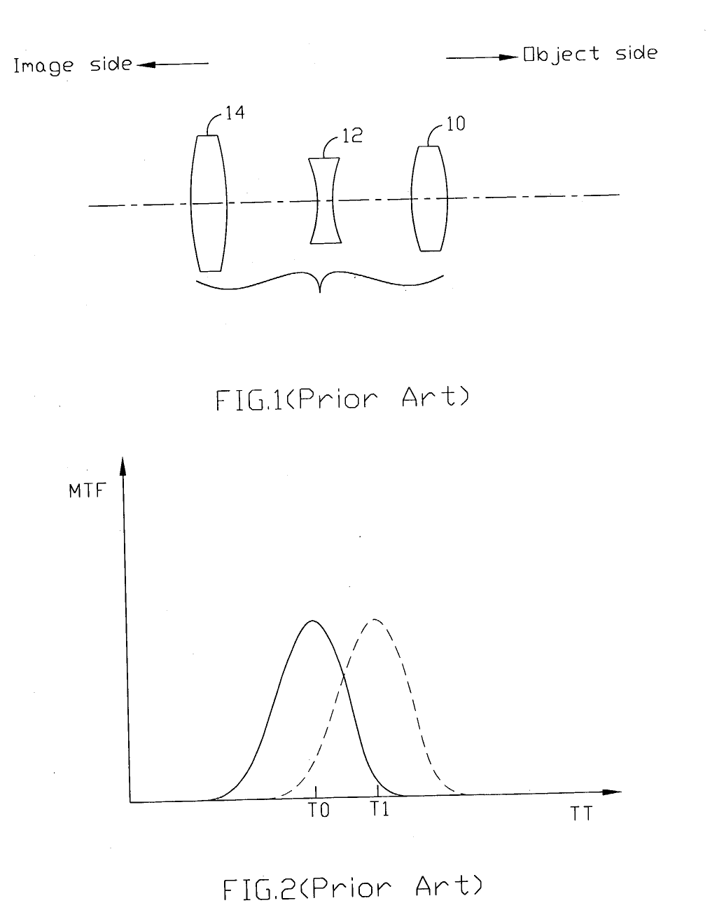

### DESCRIPTION OF THE EMBODIMENTS

The present invention provides a variable-curvature lens system including a plurality of lens having at least one plastic lens and a thermal controller associated with the plastic lens. The curvature of the plastic lens is determined depending upon the ambient temperature of the plastic lens controlled by the thermal controller. When the present lens system is employed in an image readout apparatus, such as scanner, camera, etc, the focus length of the present lens system can be flexibly adjusted upon predetermined change in ambient temperature to meet the requirements of various scanning environment. A high-performance, high-resolution image output thus can be obtained when employing the present lens system. As at least one of the three lenses of the present lens system is made of plastic material, the present lens system can reduce its weight and cost, and the manufacture cost can further be lowered since the plastic lens is easy to process. The step for adjusting the focus point of the lens system and the position of the image sensor, such as charge-coupled device (CCD), to mate with an optimum MTF value, after assembling components in the image readout apparatus, also can be omitted.

The variable-curvature lens system of the present invention can be designed in a three-element configuration, including a first lens with a convex surface directed onto an object side, a second lens with biconcave surfaces, a third lens with a convex surface directed onto an image side, at least one of the three lenses being made of plastic material, and a thermal controller is associated with the lens made of the plastic material. The thermal controller is used to change the ambient temperature of the plastic lens to deform it to change the curvature so as to adjust the focus length of the whole lens system to mate with an optimum MTF value, when using the variable-curvature lens system in the image readout apparatus. In other words, the variable-curvature lens system of the present invention can eliminate the problem of putting the image out of focus due to a temperature-dependent variation in refractive index of the plastic lens.

The variable-curvature lens system of the present invention will be described in detail in accordance with embodiments of the present invention with reference to the accompanying drawings.

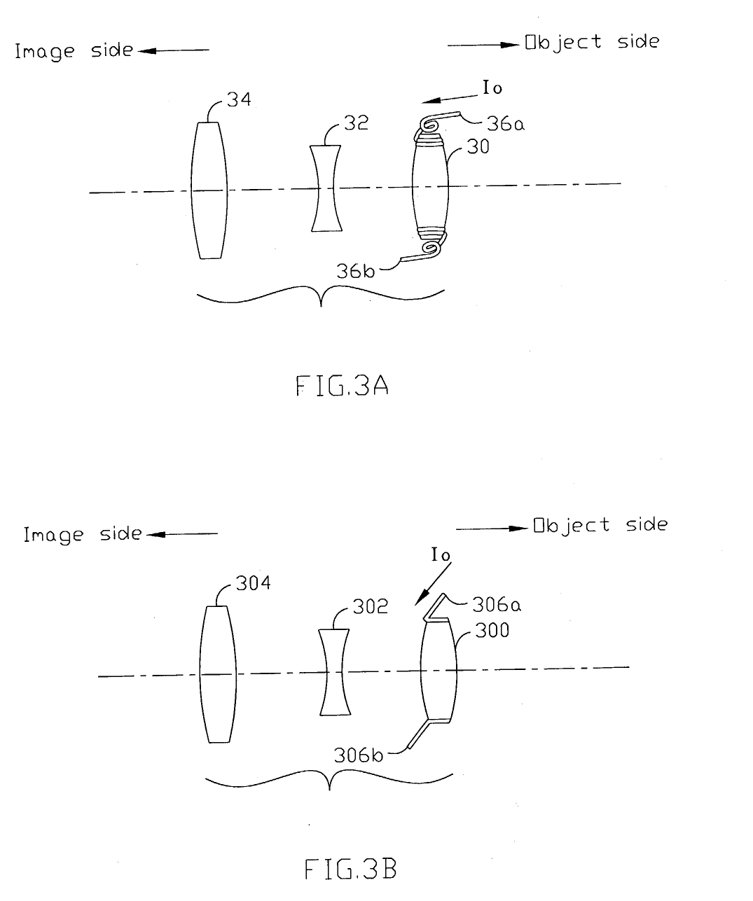

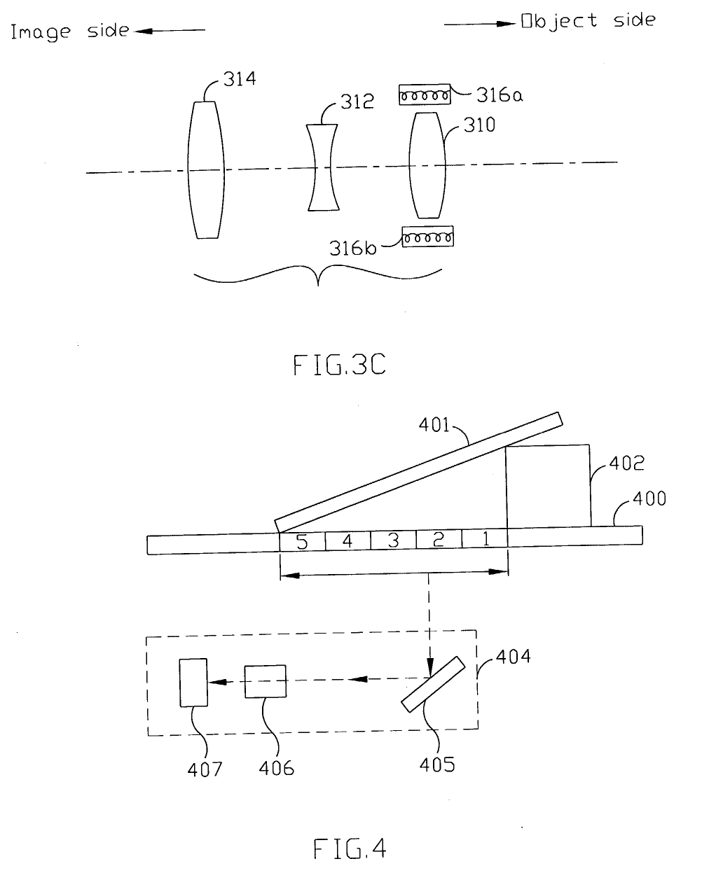

FIG. 3A is a schematic configuration of the variable-curvature lens system in accordance with a first embodiment of the present invention. The variable-curvature lens system of the first embodiment includes a first convex plastic lens 30 having a convex surface directed onto the object side, a second biconcave glass lens 32, a third convex glass lens 34 having a convex surface directed onto an image side, and a thermal controller having a pair of metal wires 36a and 36b with variable current I₀ passing through. Each of the metal wires 36a and 36b respectively wraps around one portion of the periphery of the first convex plastic lens 30, for example, respectively wrapping around one top portion and one bottom portion of the periphery. By controlling the current value passing through the metal wires 36a and 36b of the thermal controller, a predetermined ambient temperature of the first convex plastic lens 30 can be attained, and thereby thermally deforming the first convex plastic lens 30 to change the curvature in order that a desired focus length of the whole lens system can be obtained.

FIG. 3B is a schematic configuration of the variable-curvature lens system in accordance with a second embodiment of the present invention. The variable-curvature lens system of the second embodiment includes a first convex plastic lens 300 having a convex surface directed onto the object side, a second biconcave glass lens 302, a third convex glass lens 304 having a convex surface directed onto an image side, and a thermal controller having a pair of metal plates 306a and 306b with variable current I₀ passing through. Each of the metal plates 306a and 306b respectively contact one portion of the periphery of the first convex plastic lens 300, for example, respectively contacting one top portion and one bottom portion of the periphery. Like the first embodiment, by controlling the current value passing through the metal wires 306a and 306b of the thermal controller, a predetermined ambient temperature of the first convex plastic lens 300 can be attained, and thereby thermally deforming the first convex plastic lens 300 to change the curvature in order that a desired focus length of the whole lens system can be obtained.

FIG. 3C is a schematic configuration of the variable-curvature lens system in accordance with the third embodiment of the present invention. The variable-curvature lens system of the third embodiment includes a first convex plastic lens 310 having a convex surface directed onto the object side, a second biconcave glass lens 312, a third convex glass lens 314 having a convex surface directed onto an image side, and a thermal controller having a pair of coil-type heater 316a and 316b placed beside the first convex plastic lens 310. By the thermal controller, a predetermined ambient temperature of the first convex plastic lens 310 can be attained, and thereby thermally deforming the first convex plastic lens 310 to change the curvature in order that a desired focus length of the whole lens system can be obtained.

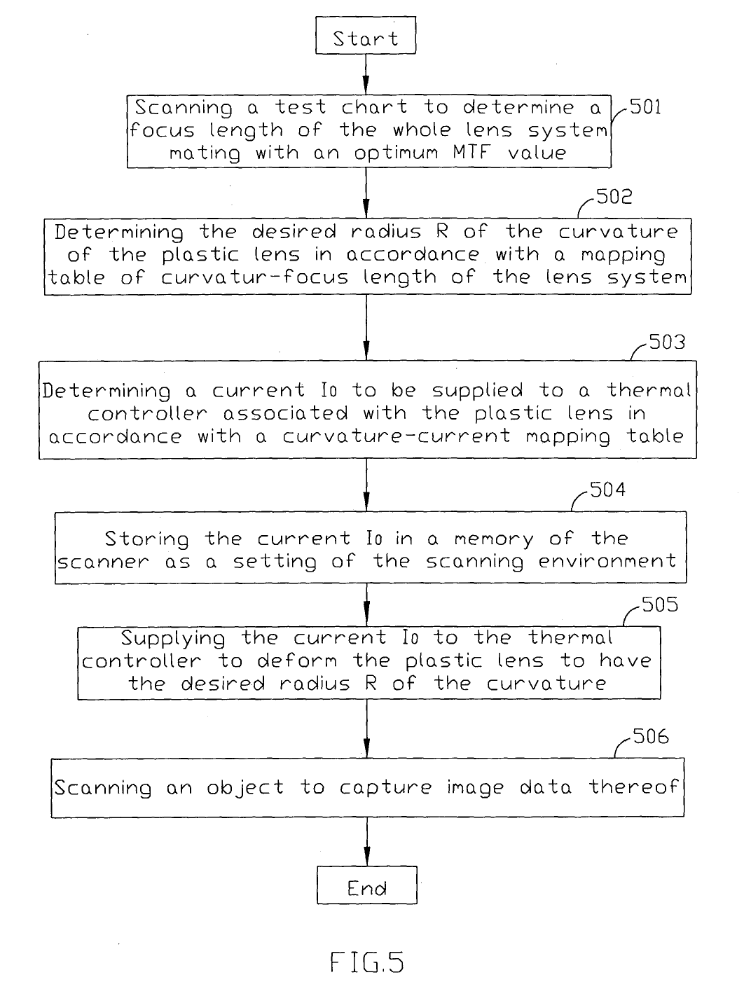

In another aspect, the present invention provides a method for adjusting the curvature of the plastic lens of the variable-curvature lens system of the present invention when adapted to the image readout apparatus. FIG. 5 is a flow chart of an example of the present method, which is described and explained in detail accompanying with the three-element configuration of FIG. 3A or FIG. 3B. The present method illustrated in FIG. 5 begins at step 501, scanning a test chart placed above a scanning board of the image readout apparatus to determine a focus length of the whole variable-curvature lens system mating with an optimum modulation transfer function (MTF) value. One method for determining the focus length of the whole variable-curvature lens system mating with the optimum MTF value is described with reference to FIG. 4, while does not be limited herein. Referring to FIG. 4, a test chart 401 is placed at a slant manner above the scanning board 400 of the image readout apparatus, which has one side resting on the scanning board 400 and another side supported by a holder 402 of a selected height above the scanning board 400 to form a plurality of scanning zones (1, 2, 3, 4, 5) of different heights. Then, the scanning chassis 404 moves linearly to scan the test chart 401 to obtain corresponding MTF distribution and derive a line graph of depth of field distribution, based on which to derive the optimum focus point. The scanning chassis 404 of fixed optical path which consists of at least one reflection mirror 405, a variable-curvature lens system 406 in a three-element configuration as shown in FIG. 3A or FIG. 3B, and a CCD 407. The test chart 401 is a line pair test chart, which has a plurality of diagonal black and white strips.

Then, go to step 502, based on the focus length of the variable-curvature lens system mating with the optimum MTF value derived from step 501, determining one desired radius R of the curvature of the first convex plastic lens 30 or 300 depending on the used variable-curvature lens system. At step 502, the desired radius R of the curvature of the first convex plastic lens 30 or 300 can be determined in accordance with a mapping table of curvature verse the focus length of the variable-curvature lens system established in a processing circuit of the image readout apparatus, for example, an application specific integrated circuit of a scanner. Next, go to step 503, in accordance with a mapping table of the radius of the curvature of the first convex plastic lens verse the current passing through the thermal controller established in the processing circuit of the image readout apparatus, for example the application specific integrated circuit of a scanner, to determine the current I₀ to be supplied to the thermal controller. Then, at step 504, the current I₀ is stored in a memory of the scanner as a setting of the scanning environment. Next, go to step 505, supplying the current I₀ to the metal wires 36a and 36b or the metal plates 306a and 306b of the thermal controller depending on the used variable-curvature lens system, to adjust the ambient temperature of the first convex plastic lens 30 or 300 to a desired temperature, thereby deforming the first convex plastic lens 30 or 300 to have the desired radius R of the curvature. The focus length of the variable-curvature lens system of fixed location mating with the optimum MTF value can thus be provided. Then, go to step 506, under the above scanning environment, a scanning operation is performed to capture the image of the object.

In accordance with the present method for adjusting the curvature of the variable-curvature lens system, the focus length of the variable-curvature lens system can be flexibly adjusted to mate with the optimum MTF value under various scanning environments. Therefore, a high-performance, high-resolution, brightness, clear profile for high image quality can be obtained.

The embodiments are only used to illustrate the present invention, not intended to limit the scope thereof. Many modifications of the embodiments can be made without departing from the spirit of the present invention.

What is claimed is:

1. A variable-curvature lens system, comprising:
a plurality of lenses having at least one plastic lens; and
a thermal controller associated with said plastic lens so that a curvature of said plastic lens is determined depending upon the ambient temperature of said plastic lens controlled by said thermal controller.

2. The variable-curvature lens system of claim 1, wherein said thermal controller includes at least a pair of metal wires having variable current passing through, each of said metal wires respectively wrapping around one portion of the periphery of said plastic lens.

3. The variable-curvature lens system of claim 1, wherein said thermal controller includes at least a pair of metal plates having variable current passing through, each of said metal plates respectively contacting with one portion of the periphery of said plastic material.

4. The variable-curvature lens system of claim 1, wherein said thermal controller includes at least a coil-type heater placed beside said plastic lens so that the ambient temperature of said plastic lens can be controlled by said thermal controller.

5. A variable-curvature lens system, comprising:
a first lens having a convex surface directed onto an object side;
a second lens made of a biconcave lens;
a third lens having a convex surface directed onto an image side; and
a thermal controller associated with at least one of said lenses being made of plastic material;
wherein the curvatures of said lens made of plastic material are determined depending upon the ambient temperature controlled by said thermal controller.

6. The variable-curvature lens system of claim 5, wherein said first lens is made of plastic material.

7. The variable-curvature lens system of claim 5, wherein said second lens is made of plastic material.

8. The variable-curvature lens system of claim 5, wherein said third lens is made of plastic material.

9. The variable-curvature lens system of claim 5, wherein said thermal controller includes at least a pair of metal wires having variable current passing through, each of said metal wires respectively wrapping around one portion of the periphery of said lens made of plastic material.

10. The variable-curvature lens system of claim 5, wherein said thermal controller includes at least a pair of metal plates having variable current passing through, each of said metal plates respectively contacting with one portion of the periphery of said lens made of plastic material.

11. The variable-curvature lens system of claim 5, wherein said thermal controller includes at least a coil-type heater placed beside said lens made of plastic material so that the ambient temperature of said lens made of plastic material can be controlled by said thermal controller.

12. A method for adjusting curvature of a variable-curvature lens system including at least a plastic lens associated with a thermal controller adapted to an image readout apparatus, comprising:
scanning a test chart placed above a scanning board of said image readout apparatus to determine a total focus length of said lens system mating with an optimum modulation transfer function value;
determining the radius R of the curvature of said plastic lens directed to an object side based on the total focus length of said lens system; and
adjusting ambient temperature of said plastic lens to deform said plastic lens to obtain the radius of the curvature by said thermal controller.

13. The method of claim 12, wherein the step of determining the radius R of the curvature of said plastic lens is based on a mapping table of curvature verse focus length of said lens system established in a processing circuit of said image readout apparatus.

14. The method of claim 12, wherein the ambient temperature of said plastic lens is determined by a current I₀ supplied to said thermal controller.

15. The method of claim 14, wherein further comprising steps of determining the current I₀ in accordance with a mapping table of the radius of the curvature of said plastic lens directed onto the object side verse the current supplied to said thermal controller established in said processing circuit of said image readout apparatus, storing the current I₀ in a memory of said image readout apparatus as a factor of the scanning setting, and providing the current I₀ to said thermal controller.
